(19) United States
(12) Patent Application Publication
(10) Pub. No.: US 2022/0194846 A1
(43) Pub. Date: Jun. 23, 2022

(54) WINDOW HAVING METAL LAYER THAT TRANSMITS MICROWAVE SIGNALS AND REFLECTS INFRARED SIGNALS

(71) Applicant: CORNING INCORPORATED, CORNING, NY (US)

(72) Inventors: Nicholas Francis Borrelli, Elmira, NY (US); Alexandre Mikhailovich Bratkovski, Corning, NY (US)

(21) Appl. No.: 17/601,738

(22) PCT Filed: Apr. 8, 2020
(86) PCT No.: PCT/US2020/027157

§ 371 Date: Oct. 6, 2021

Related U.S. Application Data
(60) Provisional application No. 62/831,839, filed on Apr. 10, 2019.

(51) Int. Cl. C03C 17/36

(52) U.S. Cl. CPC C03C 17/366; C03C 2218/328; C03C 17/3642; C03C 17/3644; C03C 17/3649; C03C 17/3681; C03C 2217/211; C03C 2217/212; C03C 2217/281; C03C 2217/219; C03C 2217/255; C03C 2217/256; C03C 2217/253; C03C 2217/252; C03C 2217/734; C03C 17/3626

(57) ABSTRACT

A window structure includes a metal layer that transmits microwave signals and reflects infrared signals. A microwave signal is a signal that has a frequency in the microwave spectrum of frequencies (a.k.a. the microwave frequency spectrum). The microwave frequency spectrum extends from 300 megahertz (MHz) to 300 gigahertz (GHz). An infrared signal is a signal that has a frequency in the infrared spectrum of frequencies (a.k.a. the infrared frequency spectrum, which extends from 300 GHz to 430 terahertz (THz)). The metal layer may be a discontinuous metal layer that's an electrically discontinuous metal layer and/or a physically discontinuous metal layer.

### CROSS-REFERENCE TO RELATED APPLICATIONS

This application claims the benefit of priority under 35 U.S.C. § 119 of U.S. Provisional Application No. 62/831,839, filed Apr. 10, 2019, the content of which is incorporated herein by reference in its entirety.

### FIELD OF THE INVENTION

Generally, the present disclosure is directed towards window structure embodiments and related methods of making and using embodiments, wherein the window structures are configured to transmit microwave signals and reflect (e.g., rejects) infrared signals. More specifically, the present disclosure is directed towards window structures that include a glass layer and a metal layer, where the metal layer is formed on the glass layer such that the method layer is configured to transmit signals having frequencies in a range from 28 gigahertz to 60 gigahertz and further configured to reflect signals having infrared frequencies.

### BACKGROUND

Recent innovations in window design have led to windows having greater energy efficiency. A window may have a single sheet (e.g., pane) of glass or multiple sheets of glass. Each sheet may include a single layer of glass or multiple layers of glass that are attached using an adhesive. The energy efficiency of modern windows often is increased by covering a surface of at least one of the sheets with a low thermal emissivity coating (a.k.a. low-E coating) and/or by filling a space between the sheets with an inert gas having relatively low thermal conductivity. Each low-E coating manages electromagnetic (EM) radiation that is incident on the coating.

Low-E coatings often are metallic. For instance, silver is commonly used as a low-E coating. Accordingly, low-E coatings typically reflect frequencies that are used in cellular communications in addition to infrared frequencies that are intended to be blocked for greater energy efficiency. A low-E coating may attenuate microwaves having a frequency of greater than 1.0 gigahertz (GHz) up to 40 dB. Building materials typically allow frequencies in the range of 0.6 GHz to 2.7 GHz, which are used by 3G and 4G cellular systems, to pass through with relatively low attenuation. Thus, attenuation of 3G and 4G frequencies by low-E coatings in windows traditionally has not been a significant issue. However, the same building materials typically attenuate frequencies in the range of 6 GHz to 100 GHz, which are used by 5G systems, quite substantially (e.g., nearly 100% in some instances). Accordingly, the reflection of microwave frequencies by traditional windows that have low-E coatings has become an even more pressing concern with the advent of 5G systems.

### SUMMARY

Various window structures are described herein that are configured to include a metal layer that transmits microwave signals and reflects (e.g., rejects) infrared signals. A microwave signal is a signal that has a frequency in the microwave spectrum of frequencies (a.k.a. the microwave frequency spectrum). The microwave frequency spectrum extends from 300 megahertz (MHz) to 300 GHz. An infrared signal is a signal that has a frequency in the infrared spectrum of frequencies (a.k.a. the infrared frequency spectrum). The infrared frequency spectrum extends from 300 GHz to 430 terahertz (THz). The metal layer may or may not be a discontinuous metal layer. A discontinuous metal layer is a metal layer that is an electrically discontinuous metal layer and/or a physically discontinuous metal layer. Accordingly, the direct current (DC) conductivity of the discontinuous metal layer may be vanishingly small.

A physically discontinuous metal layer is a metal layer that includes multiple metal portions disposed in a plane such that the metal portions do not form a continuous path of metal between opposing sides of the metal layer in the plane. For example, the metal portions may not form a continuous path of metal between any two opposing sides of the metal layer in the plane. In another example, any one or more (e.g., all) of the metal portions may not be in direct physical contact with any of the other metal portions. A metal portion that is not in direct physical contact with any of the other metal portions is defined herein to be a metal island structure. For instance, the metal island structure may be separated from the other metal portions by a non-metal substance, such as a gas (e.g., air, noble gas(es), hydrogen, or nitrogen).

An electrically discontinuous metal layer is a metal layer in which one or more boundaries inhibit flow of electrons from a first side of the metal layer to a second, opposing side of the metal layer for at least a portion of the microwave frequency spectrum. In one example, the metal layer may include metal island structures, each of which is electrically isolated from the other metal island structures in the metal layer. In accordance with this example, gaps between the metal island structures may constitute boundaries that inhibit the flow of electrons to adjacent metal island structures. In further accordance with this example, each metal island structure may be electrically conductive; however, the metal layer as a whole may have a DC conductivity that is substantially less than the DC conductivity of the individual metal island structures because the metal island structures are electrically isolated from the other metal island structures. In another example, the chemical composition of the metal layer may cause the metal layer to be electrically discontinuous.

A first example window structure includes a glass layer and a metal layer. The metal layer is formed on the glass layer. The metal layer is configured to transmit signals having frequencies in a range from 28 gigahertz to 60 gigahertz and further configured to reflect signals having infrared frequencies.

A second example window structure includes a glass substrate and a discontinuous metal layer. The discontinuous metal layer is configured to reflect infrared wavelengths. The discontinuous metal layer comprises metal island structures having a thickness and a lateral dimension disposed adjacent to the glass substrate. The thickness of the metal island structures is in a range from 1 nanometer and 7 nanometers. The lateral dimension of the metal island structures averages at least 15 nanometers.

In an example method of making a window structure, a glass layer is provided. A metal layer is formed on the glass layer. Forming the metal layer comprises configuring the metal layer to transmit signals having frequencies in a range from 28 gigahertz to 60 gigahertz and to reflect signals having infrared frequencies.

In an example method of using a window structure having a glass layer and a metal layer formed on the glass layer, infrared signals having infrared frequencies are received at the metal layer. Microwave signals having frequencies in a range from 28 gigahertz to 60 gigahertz are received at the metal layer. The microwave signals are transmitted through the metal layer based at least in part on a configuration of the metal layer. The infrared signals are reflected from the metal layer based at least in part on the configuration of the metal layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a cross-section of an example window structure having a microwave-transmissive (mw-transmissive) infrared-reflective (IR-reflective) metal layer in accordance with one or more embodiments of the present disclosure.

FIG. 2 illustrates example concentrations of elements with respect to etch time, which may be used to fabricate a window structure, in accordance with one or more embodiments of the present disclosure.

FIG. 3 is a graph including example plots of transmission and reflection with respect to wavelength for a mw-transmissive IR-reflective metal layer shown in FIG. 1, in accordance with one or more embodiments of the present disclosure.

FIG. 4 is a graph including example plots of spectral intensity with respect to wavelength for three different black bodies having respective temperatures, in accordance with one or more embodiments of the present disclosure.

FIG. 5 is a graph including example plots of loss with respect to frequency for microwave signals that pass through various structures, in accordance with one or more embodiments of the present disclosure.

FIG. 6 is a graph including example plots of transmission loss with respect to frequency for a window without a low-E coating and a window with a metal film low-E coating, in accordance with one or more embodiments of the present disclosure.

FIG. 7 is an example illustration of a metal film in which grain boundary scattering occurs, in accordance with one or more embodiments of the present disclosure.

FIG. 8 is an example illustration of a metal film in which surface roughness scattering occurs, in accordance with one or more embodiments of the present disclosure.

FIG. 9 is an example plot of resistivity with respect to thickness for an unannealed metal film, in accordance with one or more embodiments of the present disclosure.

FIG. 10 is an example plot of resistivity with respect to thickness for an annealed metal film, in accordance with one or more embodiments of the present disclosure.

FIG. 11 shows example plots of transmittance, reflectance, and absorptance with respect to frequency for silver films having respective thicknesses of 30 nm and 5 nm, in accordance with one or more embodiments of the present disclosure.

FIG. 12A illustrates behavior of a window structure having a mw-transmissive IR-reflective metal layer in accordance with one or more embodiments of the present disclosure.

FIG. 12B illustrates behavior of a window structure having a low-E metal film, in accordance with one or more embodiments of the present disclosure.

FIG. 13 shows example plots of transmittance, reflectance, and absorptance with respect to metal areal filling fraction for a discontinuous metal layer in accordance with one or more embodiments of the present disclosure.

FIGS. 14A-14C are example SEM images of discontinuous gold layers having respective thicknesses of 4 nm, 7 nm, and 10 nm in accordance with one or more embodiments of the present disclosure.

FIG. 15 is an example plot of static conductivity of a discontinuous gold layer with respect to metal areal filling fraction in accordance with one or more embodiments of the present disclosure.

FIG. 16 shows plots of conductivity with respect to frequency for gold films and for gold layers that include gold island structures in accordance with one or more embodiments of the present disclosure.

FIG. 17 shows plots of transmittance and reflectance with respect to metal areal filling fraction of a discontinuous metal layer for a microwave frequency of 10 GHz and for a near-infrared optical wavelength of 2.5 μm in accordance with one or more embodiments of the present disclosure.

FIG. 18 shows example steps of a process to fabricate a window having a discontinuous metal layer in accordance with one or more embodiments of the present disclosure.

FIG. 19 depicts a flowchart of an example method for making a window structure in accordance with one or more embodiments of the present disclosure.

FIG. 20 depicts a flowchart of an example method for using a window structure having a glass layer and a metal layer formed on the glass layer in accordance with one or more embodiments of the present disclosure.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

### II. Example Embodiments

Example window structures described herein are configured to include a metal layer that transmits microwave signals and reflects (e.g., rejects) infrared signals. A microwave signal is a signal that has a frequency in the microwave spectrum of frequencies (a.k.a. the microwave frequency spectrum). The microwave frequency spectrum extends from 300 megahertz (MHz) to 300 GHz. An infrared signal is a signal that has a frequency in the infrared spectrum of frequencies (a.k.a. the infrared frequency spectrum). The infrared frequency spectrum extends from 300 GHz to 430 terahertz (THz). The metal layer may or may not be a discontinuous metal layer. A discontinuous metal layer is a metal layer that is an electrically discontinuous metal layer and/or a physically discontinuous metal layer.

A physically discontinuous metal layer is a metal layer that includes multiple metal portions disposed in a plane such that the metal portions do not form a continuous path of metal between opposing sides of the metal layer in the plane. For example, the metal portions may not form a continuous path of metal between any two opposing sides of the metal layer in the plane. In another example, any one or more (e.g., all) of the metal portions may not be in direct physical contact with any of the other metal portions. A metal portion that is not in direct physical contact with any of the other metal portions is defined herein to be a metal island structure. For instance, the metal island structure may be separated from the other metal portions by a non-metal substance, such as a gas (e.g., air, noble gas(es), hydrogen, or nitrogen).

An electrically discontinuous metal layer is a metal layer in which one or more boundaries inhibit flow of electrons from a first side of the metal layer to a second, opposing side of the metal layer for at least a portion of the microwave frequency spectrum. In one example, the metal layer may include metal island structures, each of which is electrically isolated from the other metal island structures in the metal layer. In accordance with this example, gaps between the metal island structures may constitute boundaries that inhibit the flow of electrons to adjacent metal island structures. In further accordance with this example, each metal island structure may be electrically conductive; however, the metal layer as a whole may have a conductivity that is substantially less than the conductivity of the individual metal island structures because the metal island structures are electrically isolated from the other metal island structures. In another example, the chemical composition of the metal layer may cause the metal layer to be electrically discontinuous.

Example window structures described herein have a variety of benefits as compared to conventional window structures. For instance, the example window structures may provide a relatively high energy efficiency (e.g., by attenuating infrared frequencies) while transmitting one or more microwaves frequencies (e.g., 5G frequencies). For instance, the microwave frequencies may include 28 GHz, 37 GHz, 39 GHz, and/or 60 GHz. Accordingly, 5G devices may be able to communicate with a base station (or vice versa) through the example window structures.

The example window structures may be fabricated using conventional fabrication techniques with the addition of one extra step (e.g., annealing to form metal island structures in the metal layer). The window structures may be fully compatible with existing 4G (e.g., frequency <2.7 GHz) and developed 5G (e.g., 28 GHz, 37 GHz, 39 GHz, 60 GHz) frequency standards. The frequency response of the example window structures may be flat up to at least 10 THz. Conventional anti-reflective and barrier layers may work substantially as well on metal layers that include metal island structures as on continuous metal films, for example, because the metal island structures may be flat and have a width of tens of nanometers, which is substantially smaller than the wavelength of light.

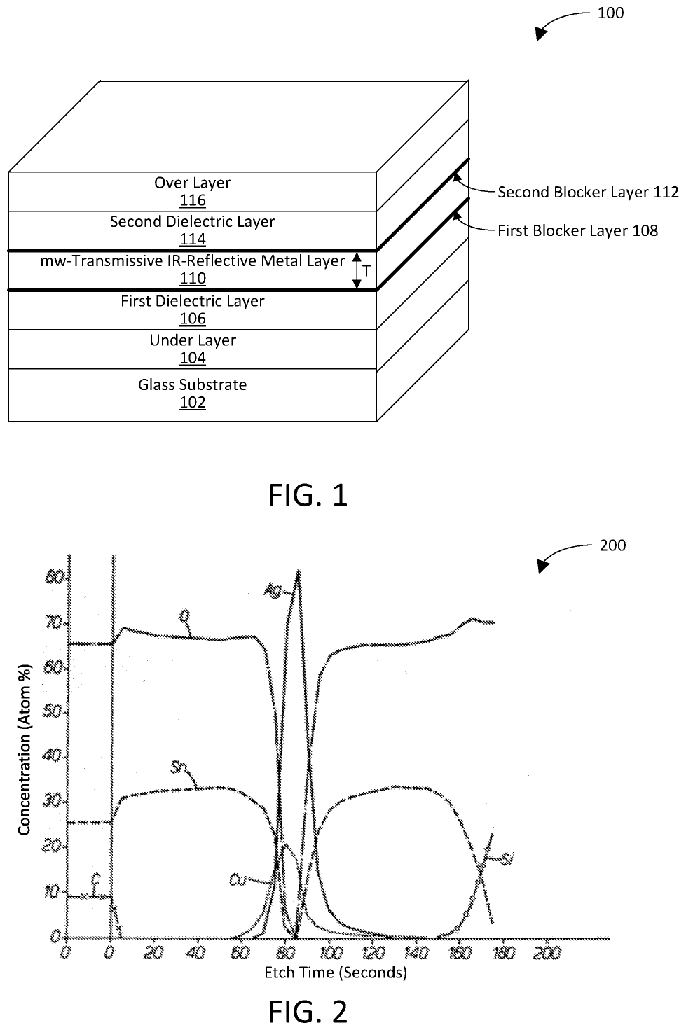

FIG. 1 is a cross-section of an example window structure 100 having a microwave-transmissive (mw-transmissive) infrared-reflective (IR-reflective) metal layer 110 in accordance with an embodiment. As shown in FIG. 1, the window structure 100 includes the following layers in order: a glass substrate 102, an under layer 104, a first dielectric layer 106, a first blocker layer 108, the mw-transmissive IR-reflective metal layer 110, a second blocker layer 112, a second dielectric layer 114, and an over layer 116.

The glass substrate 102 is a glass layer on which the other layers of the window structure 100 may be formed. The glass layer may be a glass material such as soda-lime glass (SLG), Eagle XG (EXG™) glass, or High Purity Fused Silicon™ (HPFS™) glass. It is noted that the loss tangent of SLG is approximately ten times the loss tangent of EXG™ glass (e.g., at 5G frequencies, such as 28 GHz, 37 GHz, 39 GHz, and/or 60 GHz). The loss tangent of EXG™ glass is approximately ten times the loss tangent of HPFS™ glass (e.g., at 5G frequencies, such as 28 GHz, 37 GHz, 39 GHz, and/or 60 GHz). EXG™ glass and HPFS™ glass are made and distributed by Corning Inc.

Each of the under layer 104 and the over layer 116 includes an oxide that is resistant to moisture. Accordingly, the under layer 104 and the over layer 116 may inhibit moisture from reaching (e.g., penetrating) the mw-transmissive IR-reflective metal layer 110. The under layer 104 may increase adhesion between the substrate 102 and the first dielectric layer 106 and/or increase transmittance of visible light through the mw-transmissive IR-reflective metal layer 110. The under layer 104 may include a metal nitride, a metal oxide, and/or a metal oxynitride. The over layer 116 may increase scratch resistance of the window structure 100. The first dielectric layer 106 includes an oxide that electrically isolates the mw-transmissive IR-reflective metal layer 110 from the under layer 104. The second dielectric layer 114 include an oxide that electrically isolates the mw-transmissive IR-reflective metal layer 110 from the over layer 116. Each of the first and second dielectric layers 106 and 114 may include Si₃N₄, SnO, SnO₂, ZnO:Al, WO, LaB₆, and/or other dielectric material(s). Each of the first and second blocker layers 108 and 112 includes an anti-reflective material that is configured to mitigate reflection of visible light from the window structure 100. Each of the first and second blocker layers 108 and 112 may include TiO₂, SnO, WO, LaB₆, and/or other anti-reflective material(s).

The mw-transmissive IR-reflective metal layer 110 is configured to transmit microwave signals and to reflect infrared signals. For example, the mw-transmissive IR-reflective metal layer 110 may be configured to transmit signals having frequencies in one or more portions of the microwave frequency spectrum. For instance, the mw-transmissive IR-reflective metal layer 110 may be configured to transmit signals having frequencies in a range from 6 GHz to 80 GHz, in a range from 28 GHz to 60 GHz, and/or in other range(s) in the microwave frequency spectrum.

In another example, the mw-transmissive IR-reflective metal layer 100 may provide a transmittance that is greater than or equal to a threshold transmittance across one or more portions of the microwave frequency spectrum. For instance, the threshold transmittance may be 40%, 50%, 60%, 70%, 80%, or 90%. The transmittance of the mw-transmissive IR-reflective metal layer 100 may be greater than or equal to the threshold transmittance across a range of frequencies from 28 GHz to 60 GHz, across a range of frequencies from 6 GHz to 80 GHz, and/or across other range(s) in the microwave frequency spectrum. For instance, the transmittance of the mw-transmissive IR-reflective metal layer 100 may be up to 100% across one or more ranges in the microwave frequency spectrum.

In yet another example, the mw-transmissive IR-reflective metal layer 100 may provide a transmittance in a range between 35% and 100%, in a range between 40% and 100%, in a range between 50% and 100%, or in a range between 60% and 100% across one or more portions of the microwave frequency spectrum. For instance, the mw-transmissive IR-reflective metal layer 100 may provide the aforementioned transmittance for signals having frequencies in a range between 28 GHz and 60 GHz, in a range between 6 GHz and 80 GHz, and/or in other range(s) in the microwave frequency spectrum.

In still another example, the mw-transmissive IR-reflective metal layer 100 may have a resistance that is greater than or equal to a threshold resistance with regard to signals having frequencies in one or more portions of the microwave frequency spectrum. For instance, the threshold resistance may be 5 megaohms (MΩ), 10 MΩ, 20 MΩ, 50 MΩ, 100 MΩ, or 200 MΩ. The resistance of the mw-transmissive IR-reflective metal layer 100 may be greater than or equal to the threshold resistance with regard to signals having frequencies in a range from 6 GHz to 80 GHz, in a range from 28 GHz to 60 GHz, and/or in other range(s) in the microwave frequency spectrum.

In another example, the mw-transmissive IR-reflective metal layer 100 may have a conductivity that is less than or equal to a threshold conductivity with regard to signals having frequencies in one or more portions of the microwave frequency spectrum. For instance, the threshold conductivity may be 10⁻⁴ siemens per meter (S/m), 10⁻⁵ S/m, or 10⁻⁶ S/m. The conductivity of the mw-transmissive IR-reflective metal layer 100 may be less than or equal to the threshold conductivity with regard to signals having frequencies in a range from 6 GHz to 80 GHz, in a range from 28 GHz to 60 GHz, and/or in other range(s) in the microwave frequency spectrum.

In yet another example, the mw-transmissive IR-reflective metal layer 100 may be configured to reflect at least a threshold proportion of the infrared signals. For instance, the threshold proportion may be 15%, 20%, 25%, 30%, or 40%.

In still another example, the mw-transmissive IR-reflective metal layer 100 may provide a reflectance in a range between 20% and 70%, in a range between 25% and 65%, in a range between 30% and 60%, or in a range between 35% and 55% across one or more portions of the infrared frequency spectrum. For instance, the mw-transmissive IR-reflective metal layer 100 may provide the aforementioned reflectance for signals having frequencies in a range between 25 THz and 80 THz, in a range between 30 THz and 75 THz, in a range between 35 THz and 70 THz, or in a range between 40 THz and 65 THz.

In another example, the metal layer may be a discontinuous metal layer. For instance, the metal layer may be an electrically discontinuous metal layer and/or a physically discontinuous metal layer. In an aspect of this example, the discontinuous metal layer may include metal island structures disposed in a plane. Shape and/or size of the metal islands may be random, thought the scope of the example embodiments is not limited in this respect. A layer projection area of the plane is an area of the plane that is defined by a projection of the discontinuous metal layer on the plane. An island projection area of the plane is an area of the plane that is defined by projections of the respective metal island structures on the plane. An areal coverage of the discontinuous metal layer is defined to be the island projection area divided by the layer projection area. The areal coverage may be greater than or equal to a lower threshold. For instance, the lower threshold may be 25%, 30%, 35%, 40%, or 45%. The areal coverage may be less than or equal to an upper threshold. For instance, the upper threshold may be 45%, 50%, 55%, 60%, or 65%. The areal coverage may be in a range between the lower threshold and the upper threshold.

The mw-transmissive IR-reflective metal layer 110 may include any suitable metal(s), including but not limited to gold, silver, aluminum, copper, or any combination thereof.

The mw-transmissive IR-reflective metal layer 110 is shown in FIG. 1 to have a thickness T. Accordingly, if mw-transmissive IR-reflective metal layer 110 includes metal islands, the metal islands have the thickness T. The thickness T may be greater than or equal a lower thickness threshold. For instance, the lower thickness threshold may be 0.5 nm, 1 nm, 1.5 nm, 2 nm, or 3 nm. The thickness T may be less than or equal to an upper thickness threshold. For instance, the upper thickness threshold may be 5 nm, 6 nm, 7 nm, 8 nm, or 10 nm. The thickness T may be in a range between the lower thickness threshold and the upper thickness threshold. If the mw-transmissive IR-reflective metal layer 110 includes metal islands, each of the metal islands may have a lateral dimension that is perpendicular to an axis along which the thickness T is measured. For instance, the metal islands may be configured such that an average of the lateral dimensions of the metal islands is greater than or equal to a threshold dimension. For example, the threshold dimension may be 10 nm, 12 nm, 15 nm, 20 nm, or 25 nm. For instance, the metal islands having lateral dimensions or an average lateral dimension greater than or equal to 20 nm may reduce absorption of microwave signals by the mw-transmissive IR-reflective metal layer 110. Each of the metal islands may be configured to have a lateral dimension that is substantially greater than the thickness T of the metal island.

The example layers shown in FIG. 1 are provided for illustrative purposes and are not intended to be limiting. The window structure 100 may not include one or more of the layers shown in FIG. 1. Moreover, the window structure 100 may include layer(s) in addition to or in lieu of one or more of the layers shown in FIG. 1.

FIG. 2 illustrates example concentrations of elements with respect to etch time, which may be used to fabricate a window structure (e.g., window structure 100 shown in FIG. 1), in accordance with an embodiment.

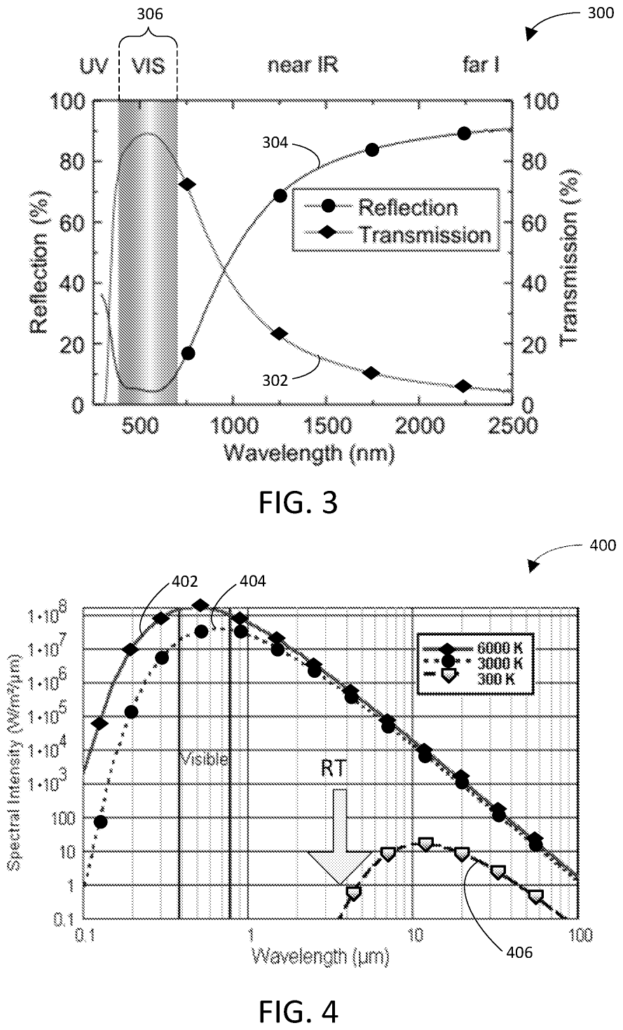

FIG. 3 is a graph 300 including example plots 302 and 304 of transmission and reflection, respectively, with respect to wavelength for a mw-transmissive IR-reflective metal layer 110 shown in FIG. 1. For plot 302, transmittance is represented along the right Y-axis of the graph 300, and wavelength is represented along the X-axis of the graph 300. For plot 304, reflectance is represented along the left Y-axis of the graph 300, and wavelength is represented along the X-axis of the graph 300.

Over the wavelengths shown in FIG. 3, the low-E window functions as a bandpass filter with peak transmission of approximately 90% for wavelengths in the visible spectrum 306, while substantially reflecting wavelengths in the infrared spectrum. The visible spectrum 306 includes wavelengths in a range from approximately 390 nanometers (nm) to 700 nm. The infrared spectrum includes wavelengths in a range from 700 nm to one millimeter (mm). Wavelengths in the infrared spectrum are referred to as “infrared wavelengths”. The example embodiments described herein may be capable of causing a low-E window to function as a bandpass filter that includes multiple passbands. For instance, the bandpass filter may include a passband that includes the visible spectrum and one or more additional passbands that include respective portion(s) of the microwave spectrum, while still substantially reflecting the infrared wavelengths. The microwave spectrum includes wavelengths in a range from one mm to one meter (m). Wavelengths in the microwave spectrum are referred to as “microwave wavelengths”.

FIG. 4 is a graph 400 including example plots 402, 404, and 406 of spectral intensity with respect to wavelength for three different black bodies having respective temperatures. Plot 402 corresponds to a black body (e.g., the sun) having a temperature of 6000 K. Plot 404 corresponds to a black body having a temperature of 3000 K. Plot 406 corresponds to a black body (e.g., a room in a building) having a temperature of 300 K. In the 300 K black body, radiation starts at a wavelength of approximately four micrometers (μm) and peaks at a wavelength of approximately 10 μm. The example embodiments described herein may be capable of reflecting the radiation associated with plot 406 while enabling radiation in the microwave spectrum to be transmitted. For instance, a window structure described herein may cause the radiation associated with plot 406 to be reflected back into a room while allowing radiation in the microwave spectrum to be transmitted into and/or out of the room through the window structure.

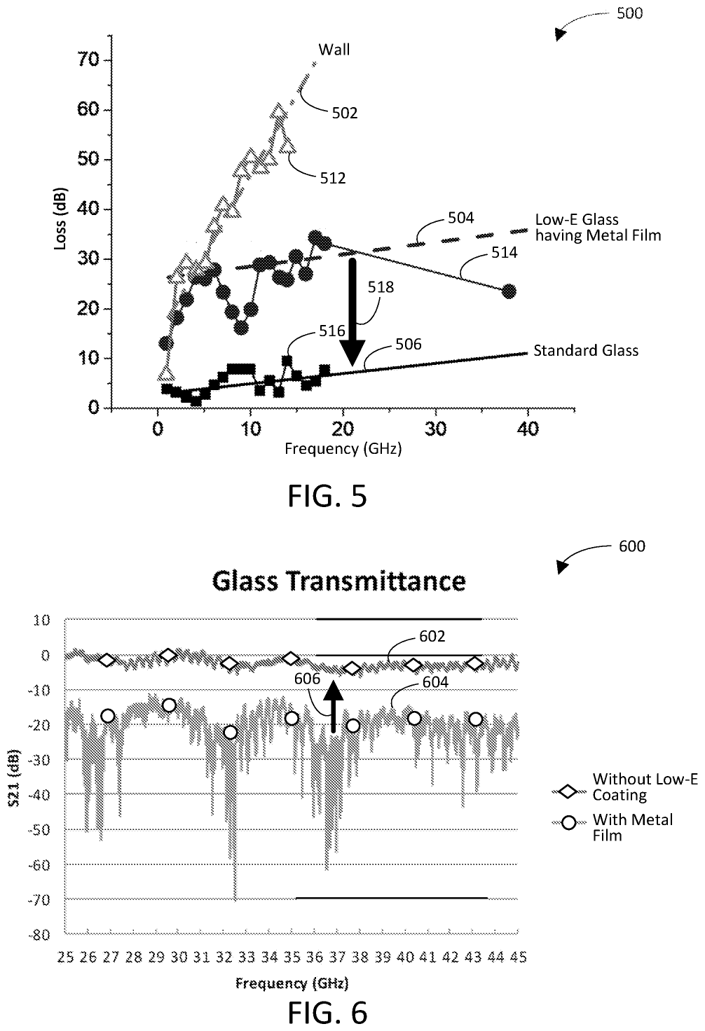

FIG. 5 is a graph 500 including example plots 502, 504, 506, 512, 514, and 516 of loss with respect to frequency for microwave signals that pass through various structures. Plots 502 and 512 depict computer-modelled loss and measured loss, respectively, of a microwave signal that passes through a wall. Plots 504 and 514 depict computer-modelled loss and measured loss, respectively, of a microwave signal that passes through a low-E glass that includes a metal film. Plots 506 and 516 depict computer-modelled loss and measured loss, respectively, of a microwave signal that passes through standard glass (i.e., glass that does not include a low-E coating). The loss was modelled and measured over a frequency range from 0.8 GHz to 40 GHz.

As depicted by plots 504 and 514, 4G signals (e.g., signals at 2.7 GHz) are blocked by the low-E glass with 26 dB loss; however, as depicted by plots 502 and 512, 4G signals travel unhindered through the wall. As further depicted by plots 504 and 514, 5G signals (e.g., signals at 28-40 GHz) are blocked by the low-E glass with 26-37 dB loss; also, as depicted by plots 502 and 512, 5G signals are substantially completely blocked by the wall (e.g., ˜100 dB loss). The blocking behavior of the low-E glass appears to be due to the metal film therein hindering the transmission of microwaves. For instance, a relatively simple calculation of transmittance is provided as follows:

Tx=1/(1+Z0/(2Rₛ)) Equation 1

where Rₛ=1/(σd) [Ω/sq.] is the resistance per unit square of the metal film; σ is the conductivity of the metal film; d is a thickness of the metal film; and Z0/2=188Ω is half of the free space impedance. In some industry standard metal films for low-E windows, Rₛ=2-5 [Ω/sq.], so that Tx≈2Rₛ/Z0«1 and the response is flat in the microwave frequency spectrum covering 4G, 5G, and up to the THz region.

By utilizing a mw-transmissive IR-reflective metal layer (e.g., mw-transmissive IR-reflective metal layer 110) in lieu of the metal film in the low-E glass, the loss that occurs when the microwave signals pass through the low-E glass is reduced. Accordingly, utilizing the mw-transmissive IR-reflective metal layer in the low-E glass causes plots 504 and 514 to shift toward plots 506 and 516, which correspond to the standard glass, as illustrated by arrow 518.

FIG. 6 is a graph 600 that includes example plots 602 and 604 of transmission loss with respect to frequency for a window without a low-E coating and a window with a metal film low-E coating. The window with the metal film low-E coating in the embodiment of FIG. 6 includes three layers of the metal film low-E coating on glass having a thickness of 30 nm for non-limiting illustrative purposes. As shown in FIG. 6, the window with the metal film low-E coating provides a relatively flat 20 dB transmission loss from 25 GHz to 45 GHz, as compared to a substantially negligible loss for the window without a low-E coating.

By utilizing a mw-transmissive IR-reflective metal layer (e.g., mw-transmissive IR-reflective metal layer 110) in lieu of the metal film low-E coating in the window, the transmission loss that occurs when microwave signals pass through the window is reduced. Accordingly, utilizing the mw-transmissive IR-reflective metal layer in the window causes plot 604 to shift toward plot 602, which corresponds to the window without a low-E coating, as illustrated by arrow 606.

Electron scattering contributes substantially to the relatively high transmission loss that occurs with respect to microwave frequencies for conventional metal film low-E coatings. For instance, the electron scattering contributes to shortening the effective mean free path of electrons through a metal film and defines the metal film's response to microwaves and light. Electron scattering in a thin film, such as a metal film low-E coating, may be caused by grain boundary scattering and/or surface roughness scattering. The example window structures described herein may mitigate the effect of such grain boundary scattering and/or surface roughness scattering.

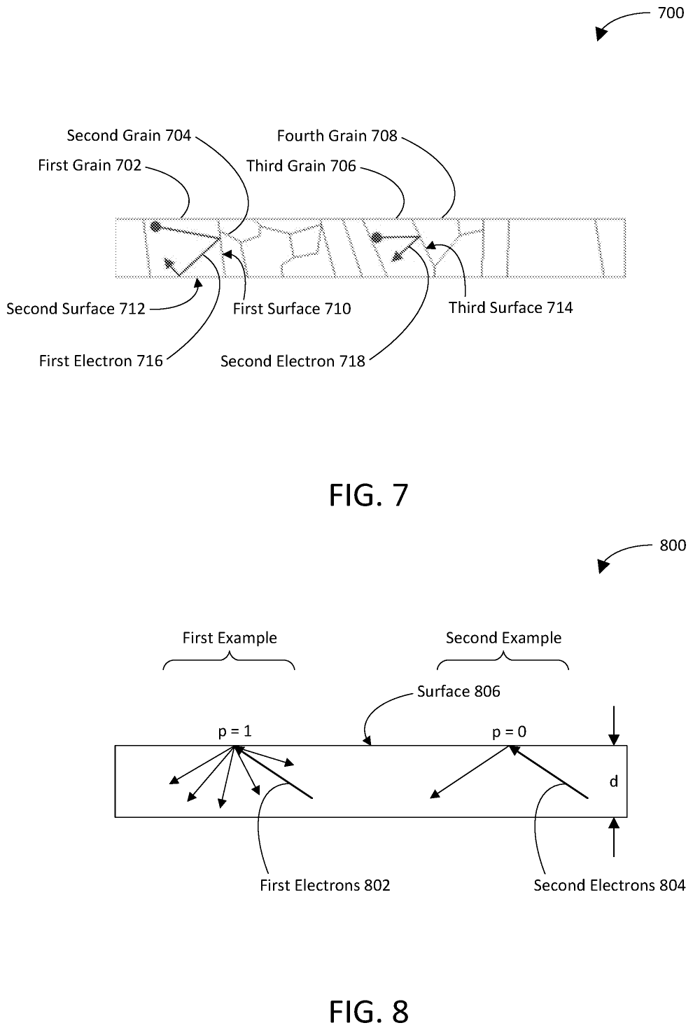

FIG. 7 is an example illustration of a metal film 700 in which grain boundary scattering occurs. As shown in FIG. 7, metal film 700 includes multiple grains. The grains include a first grain 702, a second grain 704, a third grain 706, and a fourth grain 708. A first electron 716 in the first grain 702 scatters from a first surface 710 between the first and second grains 702 and 704. The first electron 716 then scatters from a second surface 712 at an outer boundary of the metal film 700. A second electron 718 in the third grain 706 scatters from a third surface 714 between the third and fourth grains 706 and 708. The scattering of the first electron 716 from the first and second surfaces 710 and 712 inhibits transmission of the first electron 716 through the metal film 700. The scattering of the second electron 718 from the third surface 714 inhibits transmission of the second electron 718 through the metal film 700.

The grains in the metal film 700 may be any suitable sizes and may vary by any suitable amount. For instance, if the metal film 700 is 50 nm thick, the grain size may vary 19 nm. If the metal film 700 is 20 nm thick, the grain size may vary 10.8 nm. If the metal film 700 is 12 nm thick, the grain size may vary 8.4 nm, and so on. The example thicknesses and variations described herein are provided for non-limiting illustrative purposes.

The example embodiments described herein may be capable of reducing grain boundary scattering that electrons encounter in a metal layer. For example, the metal layer may be a physically discontinuous metal layer that includes metal islands. In accordance with this example, each metal island may have relatively few grains as compared to the metal layer as a whole, which may facilitate transmission of the electrons through the metal islands. In further accordance with this example, electrons may travel between the metal islands, which may facilitate their transmission through the metal layer.

FIG. 8 is an example illustration of a metal film 800 in which surface roughness scattering occurs. The surface roughness scattering in the metal film 800 may be modelled using the “Fuchs-Sondheimer model,” for example. In accordance with the Fuchs-Sondheimer model, electrons have a limited mean free path as a result of phonon and impurity scattering. In further accordance with this model, a specularity coefficient, p, may be used to specify a fraction of electrons that are scattered at a surface 806 of the metal film 800. First electrons 802 and second electrons 804 are shown to be incident on the surface 806 of the metal film 800 to illustrate differences in the amount of scattering, as indicated by respective values of the specularity coefficient. In a first example, the specularity coefficient having a value of one (i.e., p=1) results in all (i.e., 100%) of the first electrons 802 scattering at the surface 806. In a second example, the specularity coefficient having a value of zero (i.e., p=0) results in none (i.e., 0%) of the second electrons 804 scattering at the surface 806.

The example embodiments described herein may be capable of reducing surface roughness scattering that electrons encounter in a metal layer. For instance, in a physically discontinuous metal layer, electrons may travel between metal islands therein, which may reduce a number of electrons that encounter surface roughness scattering in the metal layer.

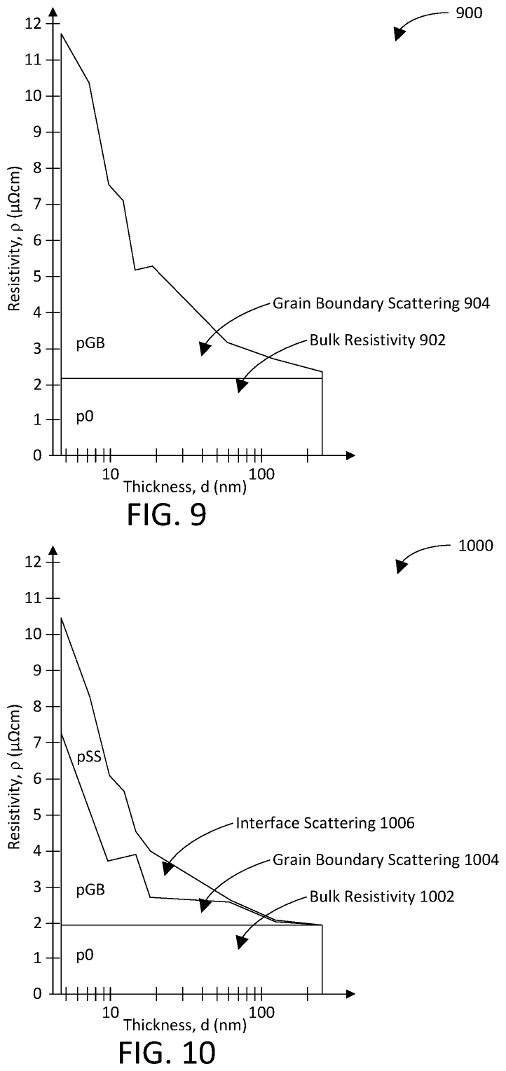

Resistivity of a metal film varies with the thickness of the metal film. FIG. 9 is an example plot 900 of resistivity with respect to thickness for an unannealed metal film. The plot 900 shows example contributions of various scattering mechanisms to the resistivity in the unannealed metal film. The contributions include a bulk resistivity contribution 902 and a grain boundary scattering contribution 904.

FIG. 10 is an example plot 1000 of resistivity with respect to thickness for an annealed metal film. The plot 1000 shows example contributions of various scattering mechanisms to the resistivity in the annealed metal film. The contributions include a bulk resistivity contribution 1002, a grain boundary scattering contribution 1004, and an interface scattering contribution 1006.

The dependence of the resistivity of a metal film may be defined by the following equation:

ρ/ρ_{bulk}=1+0.375(1−p)S*l/d+[1.5R)]*l/g Equation 2

where ρ_{bulk} is the resistivity of the bulk metal; p is the Fuchs-Sondheimer specularity factor (p=0); S is the surface roughness factor, which is in a range between 1 and 2; R is the reflectance of the grain boundaries, which is in a range between 0.07 and 0.10; l is the bulk mean free path; and g is the grain size. See S. M. Rossnagel and T. S. Kuan, “Alteration of Cu conductivity in the size effect regime,” J. Vac. Sci. Technol. B 22 (1), pp. 240-247, January/February 2004. It is noted that the product of the resistivity of the metal film, ρ, and the scattering time, τ, is constant (i.e., ρτ=constant). For example, in silver, ρτ=59±2 μΩ·cm·fs. The scattering time defines the frequency dependence of the dielectric function of the film through a simple Drude formula that is applicable for microwave and optical frequencies:

ε(ω)=ε_{∞}−(ω²p)[ω(ω+i/τ)] Equation 2

where ε_{∞}=4 for silver; ωₚ is the bulk metal plasma frequency; and τ is the scattering time, as mentioned above.

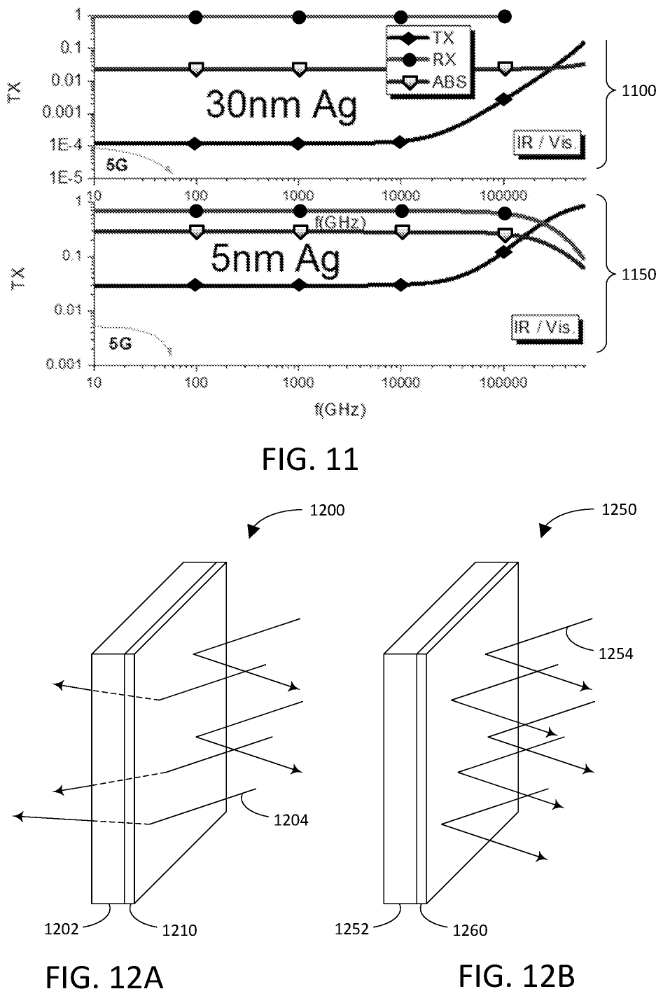

The transmittance calculated with the above parameters for silver films having respective thicknesses of 30 nm and 5 nm is shown in FIG. 11. More particularly, FIG. 11 shows example plots 1100 and 1150 of transmittance, reflectance, and absorptance with respect to frequency for silver films having the thicknesses of 30 nm and 5 nm, respectively. As shown in FIG. 11, the transmittance is relatively low and relatively flat across the microwave frequency spectrum and the portion of the infrared frequency spectrum from 300 GHz to approximately 10 THz and then increases for the remaining portion of the infrared frequency spectrum and the visible frequency spectrum. For the 5 nm-thick silver film, the transmittance is approximately 0.03 across the microwave frequency and approaches 100% in the visible frequency spectrum. The losses on the 5 nm-thick silver film are approximately 15 dB, which is substantially less than the 20+ dB loss that is associated with the 30 nm-thick silver film.

FIG. 12A illustrates behavior of a window structure 1200 having a mw-transmissive IR-reflective metal layer 1210 coupled to a glass layer 1202 in accordance with an embodiment. As depicted in FIG. 12A, the mw-transmissive IR-reflective metal layer 1210 allows at least some microwave signals 1204 to propagate through the window structure 1200. For instance, if the mw-transmissive IR-reflective metal layer 1210 is a discontinuous metal layer that includes metal islands, the mw-transmissive IR-reflective metal layer 1210 may allow the microwave signals 1204 to propagate through openings between the metal islands.

FIG. 12B illustrates behavior of a window structure 1250 having a low-E metal film 1260 coupled to a glass layer 1252. As depicted in FIG. 12B, the low-E metal film 1260 does not allow microwave signals 1254 to propagate through the window structure 1250. Rather, the low-E metal film 1260 reflects the microwave signals 1254.

Referring to FIGS. 12A and 12B, the mw-transmissive IR-reflective metal layer 1210 and the low-E metal film 1260 respond to microwave signals qualitatively differently, even if the mw-transmissive IR-reflective metal layer 1210 and the low-E metal film 1260 have the same amount of metal per unit area. It is noted that reflectance increases rather sharply with thickness of continuous films. For instance, reflectance of a microwave signal having a frequency of 9.8 GHz by a silver film may exceed 65% for a thickness of 20 nm. At optical frequencies, skin depth becomes frequency-independent and equal to c/ωₚ≈20 nm, where c=3*10¹⁰ cm/s (i.e., the speed of light). In one example, the aforementioned skin depth may be larger than an average size of metal islands in a mw-transmissive IR-reflective metal layer (e.g., mw-transmissive IR-reflective metal layer 1210) and comparable to the thickness of the metal islands; whereas, the skin depth for microwave frequencies is in the micrometer range. Despite interest in scattering on metallic subwavelength features that dates back to the early 1900s, a complete microscopic theory does not exist. Because the average size of metal islands in a mw-transmissive IR-reflective metal layer is likely to be substantially less than wavelengths of incident microwave radiation, brute force numerical methods may not be helpful. Even a simpler case relating to subwavelength metallic gratings with account for finite conductivity is a matter of debate. For a mw-transmissive IR-reflective metal layer, solving for transmittance for a given realization of a random structure and then performing an average with respect to all possible realizations of disorder may not be possible. Accordingly, it may be desirable to replace the mw-transmissive IR-reflective metal layer with an intended “equivalent” continuous film. However, such an equivalency is not currently known and may not exist.

However, because the forward scattering is dominant in the sub-wavelength geometry, one could go beyond the usual quasi-static approximation and first find the field distribution in metallic islands and dielectric background separately, averaged over the thickness of the mw-transmissive IR-reflective metal layer and without any averaging over the lateral extend of the mw-transmissive IR-reflective metal layer. The electric and magnetic fields (E and H) in the mw-transmissive IR-reflective metal layer may be expressed via incident and scattered fields via generalized Ohmic parameters (u, v) separately for metallic (uₘ, vₘ) and dielectric (u_{d}, v_{d}) areas. The parameter u represents the incident field intensity. The parameter v represents the scattering field intensity. The effective parameters (uₑ, vₑ) then may be determined via a relevant ensemble averaging of the parameters (uₘ, vₘ) and (u_{d}, v_{d}), and the transmittance of the mw-transmissive IR-reflective metal layer may be determined based on the effective parameters (uₑ, vₑ). For instance, the parameters (uₘ, vₘ) and (u_{d}, v_{d}) may be averaged using Effective Medium Theory described in classical paper by D. A. G. Bruggeman, “Berechnung verschiedener physikalischer konstanten von heterogenen substanzen,” Annals of Physics, vol. 24, pp. 636-679, 1935.

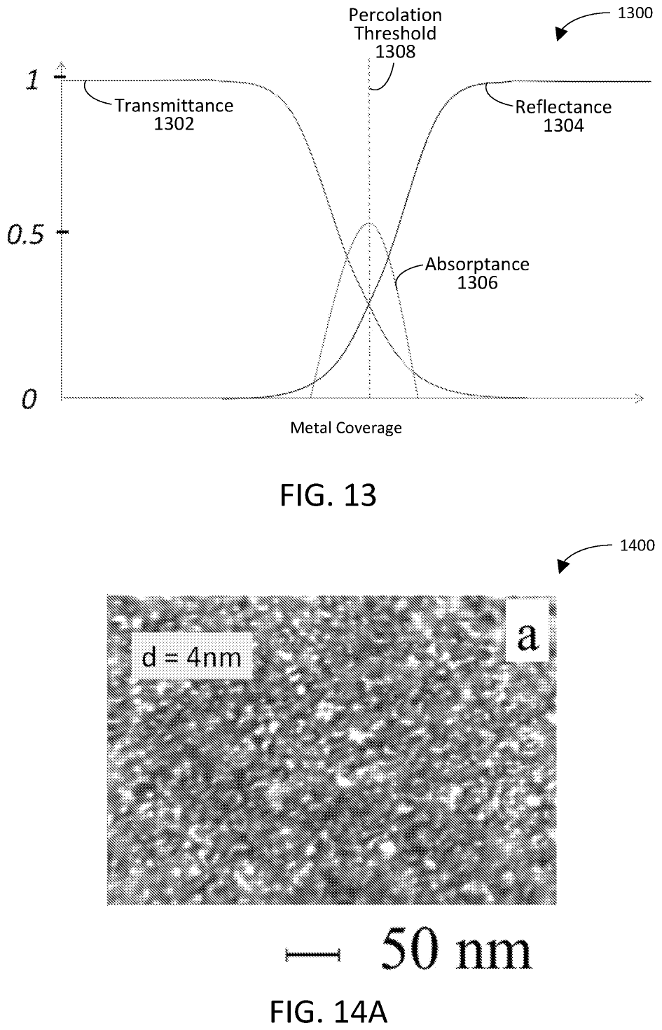

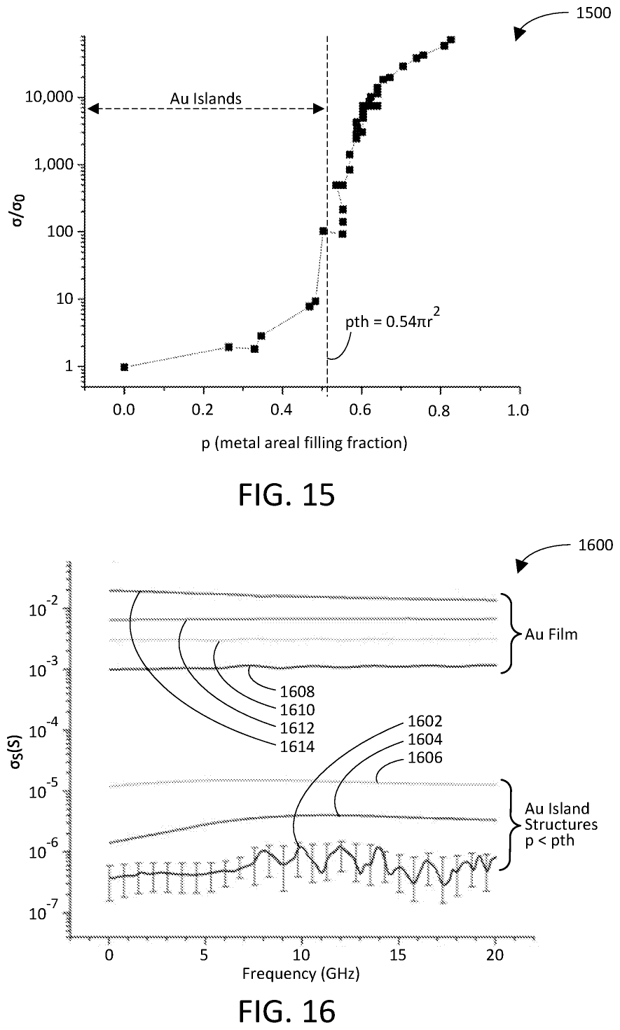

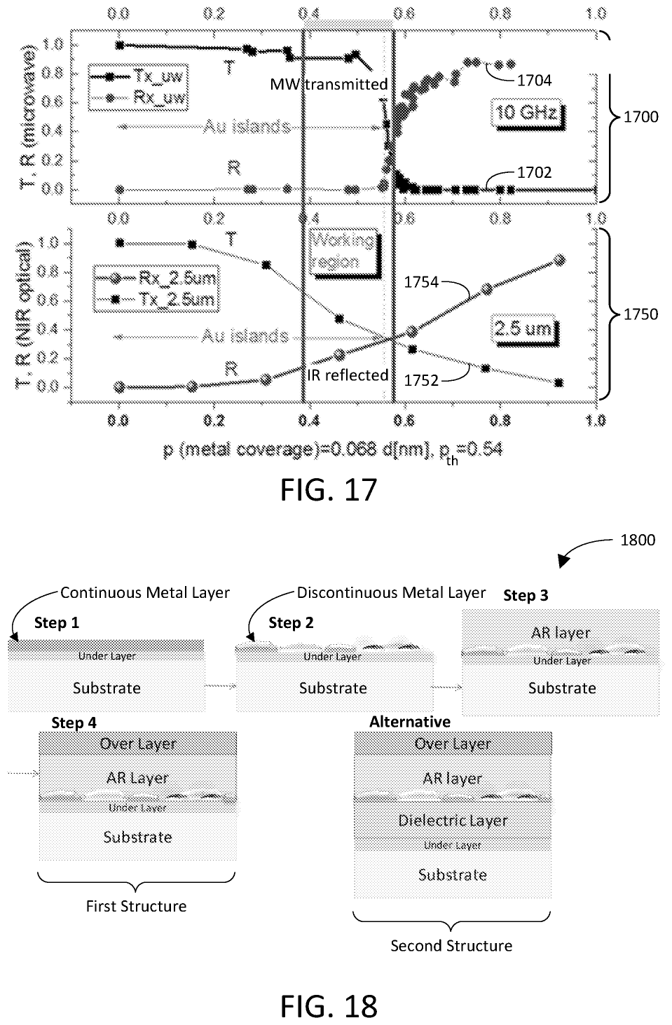

FIG. 13 shows example plots 1304, 1304, and 1306 of transmittance, reflectance, and absorptance with respect to metal areal filling fraction for a discontinuous metal layer in accordance with an embodiment. The metal areal filling fraction is the proportion of the metal layer that is metal. The plots 1304, 1304, and 1306 represent the transmittance, the reflectance, and the absorptance, respectively, for a fixed frequency of incident radiation. As shown in FIG. 13, the transmittance approaches 100% in the discontinuous metal layer for a metal areal filling fraction that is less than a percolation threshold 1308. The percolation threshold 1308 may correspond to a metal areal filling fraction of approximately 0.5, though the scope of the example embodiments is not limited in this respect. It should be noted that the transmittance for microwave frequencies changes from 0% to 100% more abruptly than the transmittance for infrared frequencies as the metal areal filling fraction is reduced. This difference may be most pronounced in a range of metal areal filling fractions near (e.g., just below or including) the percolation threshold 1308. Designing a window to have a metal layer with a metal areal filling fraction in this range may enable the window to transmit microwave frequencies while reflecting IR frequencies. The aforementioned difference will be discussed in further detail below with reference to FIGS. 15 and 17.

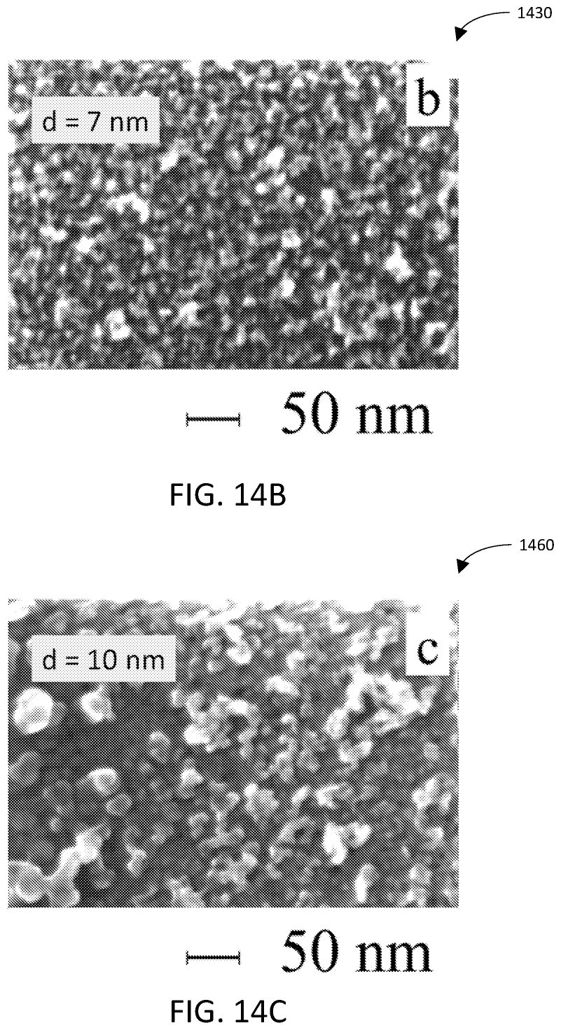

FIGS. 14A-14C are example scanning electron microscope (SEM) images 1400, 1430, and 1460 of discontinuous gold layers having respective thicknesses (d) of 4 nm, 7 nm, and 10 nm in accordance with embodiments. The SEM images 1400, 1430, and 1460 may correspond to different metal areal filling fractions. Each of the discontinuous gold layers may include gold islands that are randomly arranged in the discontinuous gold layer. Gaps between the randomly arranged gold islands may provide holes through the discontinuous gold layer, enabling microwave signals to pass through.

FIG. 15 is an example plot 1500 of static conductivity of a discontinuous gold layer with respect to metal areal filling fraction in accordance with an embodiment. As shown in FIG. 15, the conductivity of the discontinuous gold layer drops by several orders of magnitude when the metal areal filling fraction drops below the percolation threshold, pₜₕ. The metal areal filling fraction being less than the percolation threshold, pₜₕ, corresponds to the discontinuous gold layer including gold particles that are separated by gaps, thereby forming gold islands. The gaps between the gold islands reduce the conductivity of the discontinuous gold layer. This reduced conductivity may result in higher transmittance of microwave frequencies. When the metal areal filling fraction goes above the percolation threshold, pₜₕ, the gold islands are more likely to be in physical contact, resulting in clusters of the metal particles, which increases the conductivity of the discontinuous gold layer. Such an increase in conductivity may result in lower transmittance of microwave frequencies. Accordingly, it can be seen that designing the discontinuous gold layer to have a metal areal filling fraction that is less than the percolation threshold, pₜₕ, may be desirable to achieve transmission of microwave frequencies while reflecting infrared frequencies.

FIG. 16 shows plots 1600 of conductivity with respect to frequency for gold films and for gold layers that include gold island structures in accordance with an embodiment. The gold films have a metal areal filling fraction greater than the percolation threshold; whereas, the gold layers that include the gold island structures have a metal areal filling fraction less than the percolation threshold. The plots 1600 include plots 1602, 1604, 1606, and 1608, which represent conductivity of the respective gold films with respect to a frequency range from 800 MHz to 20 GHz. The plots 1600 further include plots 1610, 1612, and 1614, which represent conductivity of the respective gold layers that include gold island structures with respect to the frequency range from 800 MHz to 20 GHz. As illustrated in FIG. 16, the gold films, which correspond to plots 1602, 1604, 1606, and 1608, have greater conductivities than the gold layers that include the gold island structures, which correspond to plots 1602, 1604, and 1606, across the frequency range from 800 MHz to 20 GHz. Noteworthy is the flat response versus frequency, as expected from the model in FIG. 11. Conductivity may be inversely proportional to microwave transmittance, though the example embodiments are not limited in this respect.

FIG. 17 shows plots 1702, 1704, 1752, and 1754 of transmittance and reflectance with respect to metal areal filling fraction of a discontinuous metal layer for a microwave frequency of 10 GHz and for a near-infrared (NIR) optical wavelength of 2.5 μm in accordance with an embodiment. Plots 1702 and 1704 correspond to the microwave frequency of 10 GHz. In particular, the plot 1702 represents the transmittance with respect to the metal areal filling fraction for the microwave frequency, and the plot 1704 represents the reflectance with respect to the metal areal filling fraction for the microwave frequency. Plots 1752 and 1754 correspond to the NIR optical frequency. In particular, plot 1752 represents the transmittance with respect to the metal areal filling fraction for the NIR optical wavelength, and the plot 1754 represents the reflectance with respect to the metal areal filling fraction for the NIR optical wavelength.

As depicted by plot 1702, the transmittance for the microwave frequency increases abruptly for a metal areal filling fraction less than the percolation threshold, pₜₕ; whereas, as depicted by plot 1752, the transmittance for the NIR optical wavelength increases more gradually for a metal areal filling fraction less than the percolation threshold, pₜₕ. Accordingly, the difference between the transmittance for the microwave frequency and the transmittance for the NIR optical wavelength is relatively large (e.g., reaches a maximum) just below the percolation threshold, pₜₕ, and this difference becomes less as the metal areal filling fraction is further reduced. A working region may be defined for a range of metal areal filling fraction values based on design requirements. For example, an upper limit of the range may be selected to be near (e.g., just below, the same as, or just above) the percolation threshold, pₜₕ, and a lower limit on the range may be selected to be a metal areal filling fraction value at which a difference between the transmittance of the microwave frequency and the transmittance of the NIR optical wavelength reaches a threshold difference. In another example, the upper and lower limits of the range may be predetermined values. In FIG. 17, a working region for a range of metal areal filling fraction values is selected to be from 35% to 55% for non-limiting illustrative purposes. It will be recognized that the working region may be any suitable range of metal areal filling fraction values in which the relationship between reflecting IR signals and reflecting microwave signals is disconnected. In the working region of FIG. 17 the transmittance of the microwave frequency is approximately 90%, and the reflectance of the NIR optical wavelength is approximately 35-40%.

FIG. 18 shows example steps of a process 1800 to fabricate a window having a discontinuous metal layer in accordance with an embodiment. In step 1 of the process 1800, a continuous metal layer is deposited onto an underlayer, which is on a substrate. In step 2 of the process 1800, the continuous metal layer is modified to obtain the discontinuous metal layer. For example, if the continuous metal layer is deposited at a relatively low temperature in step 1, the continuous metal layer may be dewetted in step 2 to obtain the discontinuous metal layer. In another example, if the continuous metal layer is deposited at a relatively high temperature in step 1, the relatively high temperature may cause the continuous metal layer to form islands to obtain the discontinuous metal layer. In step 3 of the process 1800, an anti-reflection layer is deposited onto the discontinuous metal layer. Because the thickness and the lateral size of the metal islands are substantially less than the wavelengths in the microwave spectrum, the anti-reflection layer may be substantially same as the anti-reflection layers used with continuous metal films. In step 4 of the process 1800, an over layer is placed on the anti-reflective layer to provide a first structure of the window. As shown in FIG. 18, a second, alternative structure of the window may be achieved by placing a dielectric layer between the under layer and the discontinuous metal layer.

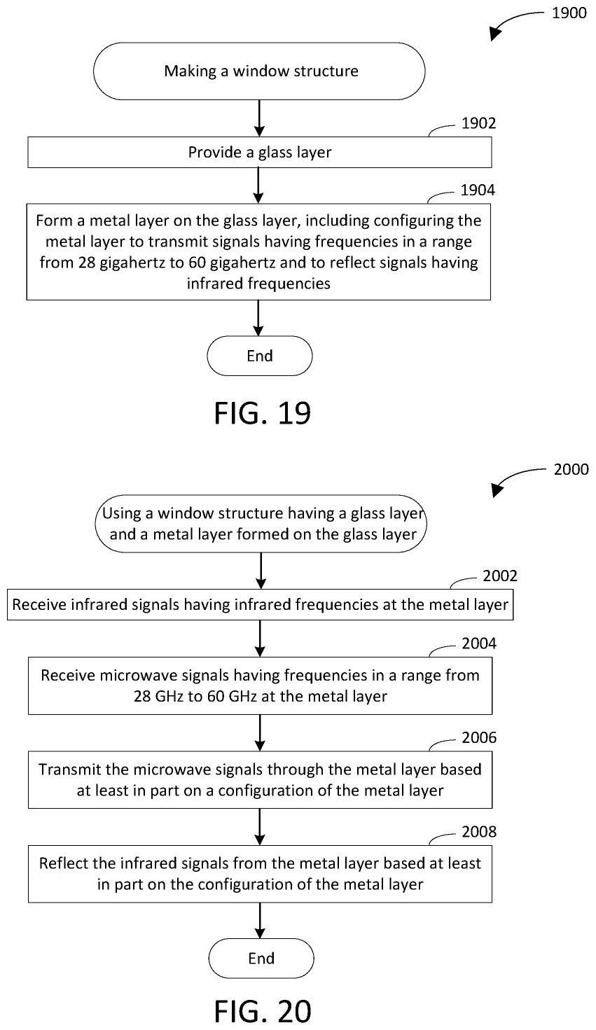

FIG. 19 depicts a flowchart 1900 of an example method for making a window structure in accordance with an embodiment. Flowchart may be performed by any suitable fabrication machinery. As shown in FIG. 19, the method of flowchart 19 begins at step 1902. In step 1902, a glass layer is provided.

At step 1904, a metal layer is formed on the glass layer. Forming the metal layer includes configuring the metal layer to transmit signals having frequencies in a range from 28 GHz to 60 GHz and to reflect signals having infrared frequencies. The metal layer may be formed on the glass layer by depositing metal on or adhering the metal to the glass layer. For instance, the metal may be spray coated or sputter coated onto the glass layer.

In an example embodiment, forming the metal layer at step 1904 includes configuring the metal layer to transmit signals having frequencies in a range from 6 GHz to 60 GHz, in a range from 28 GHz to 80 GHz, or in a range from 6 GHz to 80 GHz.

In another example embodiment, forming the metal layer at step 1904 includes configuring the metal layer to have a resistance of at least a threshold resistance with regard to the signals having the frequencies in the range from 28 gigahertz to 60 gigahertz. For instance, the threshold resistance may be 10 MΩ or 100 MΩ.

In yet another example embodiment, forming the metal layer at step 1904 includes configuring the metal layer to reflect at least a threshold percentage of the signals having the infrared frequencies. For instance, the threshold percentage may be 30%, 35%, 40%, or 45%.

In still another example embodiment, forming the metal layer at step 1904 includes configuring the metal layer to have a conductivity less than or equal to a threshold conductivity with regard to the signals having the frequencies in the range from 28 gigahertz to 60 gigahertz. For instance, the threshold conductivity may be 10⁻⁶ siemens per meter, 10⁻⁵ siemens per meter, or 10⁻⁴ siemens per meter.

In another example embodiment, forming the metal layer at step 1904 includes configuring the metal layer to provide a transmittance of at least 80% across a range of frequencies from 6 GHz to 80 GHz, across a range of frequencies from 6 GHz to 60 GHz, across a range of frequencies from 28 GHz to 80 GHz, or across a range of frequencies from 28 GHz to 60 GHz.

In yet another example embodiment, forming the metal layer at step 1904 includes configuring the metal layer to be a discontinuous metal layer. For example, configuring the metal layer to be the discontinuous metal layer may include configuring the metal layer to be an electrically discontinuous metal layer. In another example, configuring the metal layer to be the discontinuous metal layer may include configuring the metal layer to be a physically discontinuous metal layer.

In a first aspect of this embodiment, configuring the metal layer includes configuring the discontinuous metal layer to have an areal coverage in a range between 35% and 55%.

In a second aspect of this embodiment, forming the metal layer at step 1904 includes disposing the metal layer on the glass layer to provide a thickness of the metal layer that is less than a threshold thickness. In accordance with the second aspect, the thickness being less than the threshold thickness causes the metal layer to become discontinuous (e.g., electrically discontinuous and/or physically discontinuous).

In some example embodiments, one or more steps 1902 and/or 1904 of flowchart 1900 may not be performed. Moreover, steps in addition to or in lieu of steps 1902 and/or 1904 may be performed. For instance, in an example embodiment, the method of flowchart 1900 further includes applying heat to the metal layer to adhere the metal layer onto the glass layer. In another example embodiment, the method of flowchart 1900 further includes removing portions of the metal layer in response to forming the metal layer on the glass layer. In accordance with this embodiment, removing the portions of the metal layer causes the metal layer to become discontinuous (e.g., electrically discontinuous and/or physically discontinuous).

FIG. 20 depicts a flowchart 2000 of an example method for using a window structure having a glass layer and a metal layer formed on the glass layer in accordance with an embodiment. Flowchart 2000 may be performed by window structure 100 shown in FIG. 1, for example. For illustrative purposes, flowchart 2000 will be described with reference to window structure 100. Further structural and operational embodiments will be apparent to persons skilled in the relevant art(s) based on the discussion regarding the flowchart 2000.

As shown in FIG. 20, the method of flowchart 2000 begins at step 2002. In step 2002, infrared signals having infrared frequencies are received at the metal layer. In an example implementation, the mw-transmissive IR-reflective metal layer 110 receives the infrared signals.

At step 2004, microwave signals having frequencies in a range from 28 gigahertz to 60 gigahertz are received at the metal layer. In an example implementation, the mw-transmissive IR-reflective metal layer 110 receives the microwave signals.

At step 2006, the microwave signals are transmitted through the metal layer based at least in part on a configuration of the metal layer. In an example implementation, the mw-transmissive IR-reflective metal layer 110 transmits the microwave signals based at least in part on the configuration of the mw-transmissive IR-reflective metal layer 110.

At step 2008, the infrared signals are reflected from the metal layer based at least in part on the configuration of the metal layer. In an example implementation, the mw-transmissive IR-reflective metal layer 110 reflects the infrared signals based at least in part on the configuration of the mw-transmissive IR-reflective metal layer 110.

In an example embodiment, transmitting the microwave signals at step 2006 includes transmitting the microwave signals through the metal layer based at least in part on the metal layer being a discontinuous metal layer. For example, the microwave signals may be transmitted through the metal layer based at least in part on the metal layer being an electrically discontinuous metal layer. In another example, the microwave signals may be transmitted through the metal layer based at least in part on the metal layer being a physically discontinuous metal layer.

In some example embodiments, one or more steps 2002, 2004, 2006, and/or 2008 of flowchart 2000 may not be performed. Moreover, steps in addition to or in lieu of steps 2002, 2004, 2006, and/or 2008 may be performed.

### III. Further Discussion of Some Example Embodiments

A first example window structure comprises a glass layer and a metal layer.

The metal layer is formed on the glass layer. The metal layer is configured to transmit signals having frequencies in a range from 28 gigahertz to 60 gigahertz and is further configured to reflect signals having infrared frequencies.

In a first aspect of the first example window structure, the metal layer is configured to transmit signals having frequencies in a range from 6 gigahertz to 80 gigahertz.

In a second aspect of the first example window structure, the metal layer has a resistance of at least 10 megaohms with regard to the signals having the frequencies in the range from 28 gigahertz to 60 gigahertz. The second aspect of the first example window structure may be implemented in combination with the first aspect of the first example window structure, though the example embodiments are not limited in this respect.

In a third aspect of the first example window structure, the metal layer has a resistance of at least 100 megaohms with regard to the signals having the frequencies in the range from 28 gigahertz to 60 gigahertz. The third aspect of the first example window structure may be implemented in combination with the first and/or second aspect of the first example window structure, though the example embodiments are not limited in this respect.

In a fourth aspect of the first example window structure, the metal layer is configured to reflect at least 20% of the signals having the infrared frequencies. The fourth aspect of the first example window structure may be implemented in combination with the first, second, and/or third aspect of the first example window structure, though the example embodiments are not limited in this respect.

In a fifth aspect of the first example window structure, the metal layer has a conductivity less than or equal to 10⁻⁵ siemens per meter with regard to the signals having the frequencies in the range from 28 gigahertz to 60 gigahertz. The fifth aspect of the first example window structure may be implemented in combination with the first, second, third, and/or fourth aspect of the first example window structure, though the example embodiments are not limited in this respect.

In a sixth aspect of the first example window structure, the metal layer provides a transmittance of at least 80% across a range of frequencies from 28 GHz to 60 GHz. The sixth aspect of the first example window structure may be implemented in combination with the first, second, third, fourth, and/or fifth aspect of the first example window structure, though the example embodiments are not limited in this respect.

In a seventh aspect of the first example window structure, the metal layer provides a transmittance of at least 80% across a range of frequencies from 6 GHz to 80 GHz. The seventh aspect of the first example window structure may be implemented in combination with the first, second, third, fourth, fifth, and/or sixth aspect of the first example window structure, though the example embodiments are not limited in this respect.

In an eighth aspect of the first example window structure, the metal layer is an electrically discontinuous metal layer. The eighth aspect of the first example window structure may be implemented in combination with the first, second, third, fourth, fifth, sixth, and/or seventh aspect of the first example window structure, though the example embodiments are not limited in this respect.

In an implementation of the eighth aspect of the first example window structure, the electrically discontinuous metal layer has an areal coverage in a range between 35% and 55%.

A second example window structure comprises a glass substrate and a discontinuous metal layer. The discontinuous metal layer is configured to reflect infrared wavelengths. The discontinuous metal layer comprises metal island structures having a thickness and a lateral dimension disposed adjacent to the glass substrate. The thickness of the metal island structures is in a range from 1 nanometer and 7 nanometers. The lateral dimension of the metal island structures averages at least 15 nanometers.

In a first aspect of the second example window structure, the discontinuous metal layer has an areal coverage in a range between 35% and 55%.

In a second aspect of the second example window structure, the discontinuous metal layer provides a transmittance in a range between 0.4 and 1.0 for signals having frequencies in a range between 6 GHz and 80 GHz and a reflectance in a range between 0.3 and 0.6 for signals having frequencies in a range between 30 terahertz and 75 terahertz. The second aspect of the second example window structure may be implemented in combination with the first aspect of the second example window structure, though the example embodiments are not limited in this respect.

In a third aspect of the second example window structure, the discontinuous metal layer includes at least one of gold, silver, aluminum, or copper. The third aspect of the second example window structure may be implemented in combination with the first and/or second aspect of the second example window structure, though the example embodiments are not limited in this respect.

In a fourth aspect of the second example window structure, the second example window structure further comprises a dielectric layer that includes at least one of Si₃N₄, SnO, WO, or LaB₆. In accordance with the fourth aspect, the discontinuous metal layer is between the dielectric layer and the glass layer. The fourth aspect of the second example window structure may be implemented in combination with the first, second, and/or third aspect of the second example window structure, though the example embodiments are not limited in this respect.

In a fifth aspect of the second example window structure, the second example window structure further comprises an anti-reflective layer between the glass substrate and the discontinuous metal layer, the anti-reflective layer including at least one of TiO₂, SnO, WO, or LaB₆. The fifth aspect of the second example window structure may be implemented in combination with the first, second, third, and/or fourth aspect of the second example window structure, though the example embodiments are not limited in this respect.

In an example method of making a window structure, a glass layer is provided. A metal layer formed on the glass layer. Forming the metal layer comprises configuring the metal layer to transmit signals having frequencies in a range from 28 gigahertz to 60 gigahertz and to reflect signals having infrared frequencies.

In a first aspect of the example method, forming the metal layer comprises configuring the metal layer to transmit signals having frequencies in a range from 6 gigahertz to 80 gigahertz.

In a second aspect of the example method, forming the metal layer comprises configuring the metal layer to have a resistance of at least 10 megaohms with regard to the signals having the frequencies in the range from 28 gigahertz to 60 gigahertz. The second aspect of the example method may be implemented in combination with the first aspect of the example method, though the example embodiments are not limited in this respect.

In a third aspect of the example method, forming the metal layer comprises configuring the metal layer to have a resistance of at least 100 megaohms with regard to the signals having the frequencies in the range from 28 gigahertz to 60 gigahertz. The third aspect of the example method may be implemented in combination with the first and/or second aspect of the example method, though the example embodiments are not limited in this respect.

In a fourth aspect of the example method, forming the metal layer comprises configuring the metal layer to reflect at least 30% of the signals having the infrared frequencies. The fourth aspect of the example method may be implemented in combination with the first, second, and/or third aspect of the example method, though the example embodiments are not limited in this respect.

In a fifth aspect of the example method, forming the metal layer comprises configuring the metal layer to have a conductivity less than or equal to 10⁻⁵ siemens per meter with regard to the signals having the frequencies in the range from 28 gigahertz to 60 gigahertz. The fifth aspect of the example method may be implemented in combination with the first, second, third, and/or fourth aspect of the example method, though the example embodiments are not limited in this respect.

In a sixth aspect of the example method, forming the metal layer comprises configuring the metal layer to provide a transmittance of at least 80% across a range of frequencies from 28 GHz to 60 GHz. The sixth aspect of the example method may be implemented in combination with the first, second, third, fourth, and/or fifth aspect of the example method, though the example embodiments are not limited in this respect.

In a seventh aspect of the example method, forming the metal layer comprises configuring the metal layer to provide a transmittance of at least 80% across a range of frequencies from 6 GHz to 80 GHz. The seventh aspect of the example method may be implemented in combination with the first, second, third, fourth, fifth, and/or sixth aspect of the example method, though the example embodiments are not limited in this respect.

In an the parameters (uₘ, vₘ) and (u_{d}, v_{d}) eighth aspect of the example method, forming the metal layer comprises configuring the metal layer to be an electrically discontinuous metal layer. The eighth aspect of the example method may be implemented in combination with the first, second, third, fourth, fifth, sixth, and/or seventh aspect of the example method, though the example embodiments are not limited in this respect.

In a first implementation of the eighth aspect of the example method, configuring the metal layer comprises configuring the electrically discontinuous metal layer to have an areal coverage in a range between 35% and 55%.

In a second implementation of the eighth aspect of the example method, forming the metal layer comprises disposing the metal layer on the glass layer to provide a thickness of the metal layer that is less than a threshold thickness. In accordance with the second implementation, the thickness being less than the threshold thickness causes the metal layer to become electrically discontinuous.

In a third implementation of the eighth aspect of the example method, the example method further comprises removing portions of the metal layer in response to forming the metal layer on the glass layer. In accordance with the third implementation, removing the portions of the metal layer causes the metal layer to become electrically discontinuous.

In an example method of using a window structure having a glass layer and a metal layer formed on the glass layer, infrared signals having infrared frequencies are received at the metal layer. Microwave signals having frequencies in a range from 28 gigahertz to 60 gigahertz are received at the metal layer. The microwave signals are transmitted through the metal layer based at least in part on a configuration of the metal layer. The infrared signals are reflected from the metal layer based at least in part on the configuration of the metal layer.

In a first aspect of the example method, transmitting the microwave signals comprises transmitting the microwave signals through the metal layer based at least in part on the metal layer being an electrically discontinuous metal layer.

### IV. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. A window structure comprising:
a glass substrate; and
a discontinuous metal layer configured to reflect infrared wavelengths, wherein the discontinuous metal layer comprises metal island structures having a thickness and a lateral dimension disposed adjacent to the glass substrate, wherein the thickness of the metal island structures is in a range from 1 nanometer and 7 nanometers, and wherein the lateral dimension of the metal island structures averages at least 15 nanometers.

2. The window structure of claim 1, wherein the discontinuous metal layer has an areal coverage in a range between 35% and 55%.

3. The window structure of claim 1, wherein the discontinuous metal layer provides a transmittance in a range between 0.4 and 1.0 for signals having frequencies in a range between 6 GHz and 80 GHz and a reflectance in a range between 0.3 and 0.6 for signals having frequencies in a range between 30 terahertz and 75 terahertz.

4. The window structure of claim 1, wherein the discontinuous metal layer includes at least one of gold, silver, aluminum, or copper.

5. The window structure of claim 1, further comprising:
a dielectric layer that includes at least one of Si₃N₄, SnO, WO, or LaB₆;
wherein the discontinuous metal layer is between the dielectric layer and the glass layer.

6. The window structure of claim 1, further comprising:
an anti-reflective layer between the glass substrate and the discontinuous metal layer, the anti-reflective layer including at least one of TiO₂, SnO, WO, or LaB₆.

7. A window structure comprising:
a glass layer; and
a metal layer formed on the glass layer, the metal layer configured to transmit signals having frequencies in a range from 28 gigahertz to 60 gigahertz and further configured to reflect signals having infrared frequencies.

8. The window structure of claim 7, wherein the metal layer is configured to transmit signals having frequencies in a range from 6 gigahertz to 80 gigahertz.

9. The window structure of claim 7, wherein the metal layer has a resistance of at least 10 megaohms with regard to the signals having the frequencies in the range from 28 gigahertz to 60 gigahertz.

10. The window structure of claim 7, wherein the metal layer has a resistance of at least 100 megaohms with regard to the signals having the frequencies in the range from 28 gigahertz to 60 gigahertz.

11. The window structure of claim 7, wherein the metal layer is configured to reflect at least 20% of the signals having the infrared frequencies.

12. The window structure of claim 7, wherein the metal layer has a conductivity less than or equal to 10⁻⁵ siemens per meter with regard to the signals having the frequencies in the range from 28 gigahertz to 60 gigahertz.

13. The window structure of claim 7, wherein the metal layer provides a transmittance of at least 80% across a range of frequencies from 28 GHz to 60 GHz.

14. The window structure of claim 7, wherein the metal layer provides a transmittance of at least 80% across a range of frequencies from 6 GHz to 80 GHz.

15. The window structure of claim 7, wherein the metal layer is an electrically discontinuous metal layer.

16. The window structure of claim 15, wherein the electrically discontinuous metal layer has an areal coverage in a range between 35% and 55%.

17. A method of making a window structure, the method comprising:
providing a glass layer; and
forming a metal layer on the glass layer, said forming the metal layer comprising:
configuring the metal layer to transmit signals having frequencies in a range from 28 gigahertz to 60 gigahertz and to reflect signals having infrared frequencies.

18. The method of claim 17, wherein forming the metal layer comprises:
configuring the metal layer to have a resistance of at least 10 megaohms with regard to the signals having the frequencies in the range from 28 gigahertz to 60 gigahertz.

19. The method of claim 17, wherein forming the metal layer comprises:
configuring the metal layer to reflect at least 30% of the signals having the infrared frequencies.

20. The method of claim 17, wherein forming the metal layer comprises:
configuring the metal layer to have a conductivity less than or equal to 10⁻⁵ siemens per meter with regard to the signals having the frequencies in the range from 28 gigahertz to 60 gigahertz.

21. The method of claim 17, wherein forming the metal layer comprises:
configuring the metal layer to provide a transmittance of at least 80% across a range of frequencies from 28 GHz to 60 GHz.

22. The method of claim 17, wherein forming the metal layer comprises:
configuring the metal layer to be an electrically discontinuous metal layer.

23. The method of claim 22, wherein configuring the metal layer comprises:
configuring the electrically discontinuous metal layer to have an areal coverage in a range between 35% and 55%.

24. The method of claim 22, further comprising:
removing portions of the metal layer in response to forming the metal layer on the glass layer;
wherein removing the portions of the metal layer causes the metal layer to become electrically discontinuous.

25.-26. (canceled)
